(19) United States
(12) Patent Application Publication
(10) Pub. No.: US 2008/0168119 A1
(43) Pub. Date: Jul. 10, 2008

(54) Variable Internet Banner

(75) Inventors: Peter Van Der Helm, Amsterdam (NL); Roland M. Elvers, Amsterdam (NL); Jordi Haarman, Amsterdam (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Drbanner Licenses B.V., Amsterdam (NL)

(21) Appl. No.: 11/908,035

(22) PCT Filed: Nov. 8, 2005
(86) PCT No.: PCT/NL2005/050034

§ 371 Date: Dec. 21, 2007

(30) Foreign Application Priority Data
Mar. 8, 2005 (NL) 1028483

(51) Int. Cl. G06F 17/00; G06F 15/16

(52) U.S. Cl. 709/201; 715/244

(57) ABSTRACT

The invention relates to a banner (1) capable of being displayed on a part of a display area (5) of a display panel (4) which display area further is capable of displaying a selection member (12). The banner comprises variation means capable of varying the appearance (11A-11D) of at least a portion of said banner on said display area in dependence on the distance (d) between said selection member and a predetermined part (L) of or outside said display area. Consequently, the attention for the banner is increase.

### CROSS-REFERENCE TO RELATED APPLICATION

This application is a Section 371 National Stage Application of International Application PCT/NL2005/050034 filed Nov. 8, 2005 and published as WO 2006/096046 in English.

### FIELD OF THE INVENTION

The invention relates to a banner capable of being displayed on a part of a display area of a display panel. More specifically, the invention relates to a digital banner capable of being displayed on a part of a display area of a display panel which display area further is capable of displaying a selection member.

### BACKGROUND OF THE INVENTION

The architecture of the internet follows a conventional client-server model. The terms “client” and “server” are used to refer to a computer's general role as a requester of data (the client) or provider of data (the server). web browsers reside in clients and specially formatted “web documents” reside on Internet (web) servers. web clients and web servers communicate using a protocol called “HyperText Transfer Protocol” (HTTP). In operation, a browser opens a connection to a server and initiates a request for a document or a web page including content. The server delivers the requested document or web page, typically in the form coded in a standard “HyperText Markup Language” (HTML) format. After the document or web page is delivered, the connection is closed and the browser displays the document or web page to the user.

The internet comprises a worldwide computer network that communicates using the Internet Protocol (IP). To access a document on the web, the user enters a URL for the web document into a browser program executing on a client system with a connection to the Internet. The web browser then sends a request in accordance with the HTTP protocol to the web server that has the web document using the URL. The web server responds to the request by transmitting the requested object to the client. Such objects often contain hyperlinks to other web documents. Generally, users view the content delivered in the web pages and may select hyperlinks to other sub pages of a web site, or to (pages of) entirely different web sites.

The internet is an advertising supported medium, wherein publishers sell advertising “space” on their web site to third parties or use this space themselves in what are referred to as banner ads or banners. These banners may be delivered to the user by the web page's provider, or may be provided by a third party advertisement server. When an interested user selects the advertisement (by “clicking” on the banner) the user is generally forwarded to another web page or site associated with the advertisement. The use of banner ads to deliver interactive functionality is previously known, see, e.g., U.S. Pat. No. 6,379,251.

A disadvantage of currently known banners is that an individual banner often attracts only little attention because of the relatively static appearance and the dramatic increase in the amount of banners in recent years. Even animated banners attract little attention, because this kind of banner has also become commonplace. Furthermore, banners are often perceived as annoying.

### SUMMARY OF THE INVENTION

It is an object of the invention to provide a banner that reduces or eliminates one or more of the disadvantages.

It is a further object of the invention to provide a banner that is capable of increasing attention for this banner.

It is a still further object of the invention to provide a banner that will generate a higher click through rate and therefore more traffic to an advertiser's site and/or more sales of the product of service that is communicated in the banner.

It is a still further object of the invention to provide a more interactive banner.

The invention provides a banner capable of being displayed on a part of a display area of a display panel which display area further is capable of displaying a selection member. Preferably, the banner is capable of being selected by said selection member. The banner or another component comprises variation means capable of varying the appearance of at least a portion of said banner on said display area in dependence on the distance between said selection member and a pre-determined part of or outside said display area.

By determining or measuring the distance between the selection member, e.g. a cursor of a computer mouse or another selection means, and a predetermined part of said display area, movement of the selection member varies the appearance of at least a part of the banner. Since the user of a computing means typically moves the cursor, the appearance of the banner will change which is likely to be noticed by this user. Because the user has control over the banner appearance by means of moving the selection means, the attention for the banner is increased. Preferably, the appearance of at least said portion of the banner changes (quasi-)continuously with the distance between the selection member and the predetermined part of the display area. Preferably, the variation of the appearance of at least said portion of the banner includes more than two, preferably more than three or more than four appearances for various distances between the selection member and the predetermined part. It should be appreciated that preferably the transition of the appearances for different distances is smooth. Preferably, the appearance of the (portion of) the banner (only) varies for positions of the selection means outside the part displaying the banner itself.

It should be appreciated that the predetermined part defining the distance with the selection member may be a point, line, or area, preferably located in, on or near the boundary of the banner.

Further, it should be appreciated that the variation of the ‘appearance’ should be interpreted to include any visible and/or audible effect, such as variation of the brightness, colour, content, focus, perspective, size, shape and sound associated with said at least portion of said banner. Variation of the appearance of at least a portion of the banner may leave the total area reserved for the banner in its original shape and size.

Finally, it is noted that determination or measurement of the distance or position between the selection member and the predetermined part is not necessarily performed by the variation means. The variation means may, e.g., receive a distance parameter or a related parameter or value as determined by another component (e.g. a javascript running on the browser) as an input to display a certain appearance an appearance.

In a particularly advantageous embodiment of the invention, an appearance of said banner is associated with a link comprising an address code for retrieving data and said variation means is capable of changing said address code when said appearance varies. This embodiment allows different advertisements or replacements of one or more objects (e.g. different products of an advertiser) within one banner dependent on said distance while enabling a user to retrieve data corresponding to the advertisement or object(s) shown for that particular distance or range of distances by clicking outside the banner. Data may be retrieved either by opening a new window or replacing a window by deeplinking to (a page of) another website or by retrieving new data for the banner itself.

In an embodiment of the invention, the variation means is capable of selecting one or more banner appearances out of a plurality of banner appearances corresponding to said distance or range of said distances and displaying said banner appearances. This is particularly true for an embodiment wherein a selection is made out of a number of frames that may be played to display a corresponding number of appearances. However, it should be appreciated that instead of selecting an appearance, an appearance may be created from scratch or calculated on the basis of an existing appearance.

In an embodiment of the invention, the display panel is capable of receiving image data from a computing unit to display said banner and said variation means is capable of selecting one or more banner appearances out of a plurality of banner appearances available at said computing unit corresponding to said distance or range of said distances and displaying said banner appearances. In this embodiment, the variation of the appearance of the at least one portion of the banner is accomplished without data transfer over e.g. the internet, since all variations of the appearances are already available at the computing unit.

The invention also relates to a method for providing a banner and a computer program including a set of instructions capable to perform such a method.

Furthermore, the invention relates to a server arranged for providing a banner.

The invention will be further illustrated with reference to the attached drawings, which schematically show a preferred embodiment according to the invention. It will be understood that the invention is not in any way restricted to this specific and preferred embodiment.

### BRIEF DESCRIPTION OF THE DRAWINGS

In the drawings:

FIG. 1 shows a system for providing a banner according to an embodiment of the invention;

FIG. 2 is a schematic illustration of a display area of a display panel comprising a banner on a part of said display area according to an embodiment of the invention;

FIGS. 3A-3D depict various stages of operating the banner according to an embodiment of the invention;

FIGS. 4A-4D depict various stages of operating the banner according to an embodiment of the invention;

FIGS. 5A-5D depict various stages of operating the banner according to an embodiment of the invention;

FIGS. 6A and 6B show flow charts illustrative of the operation of an embodiment of the invention, and

FIGS. 7A and 7B illustrate data flows between devices of the system of FIG. 1.

### DETAILED DESCRIPTION OF THE DRAWINGS

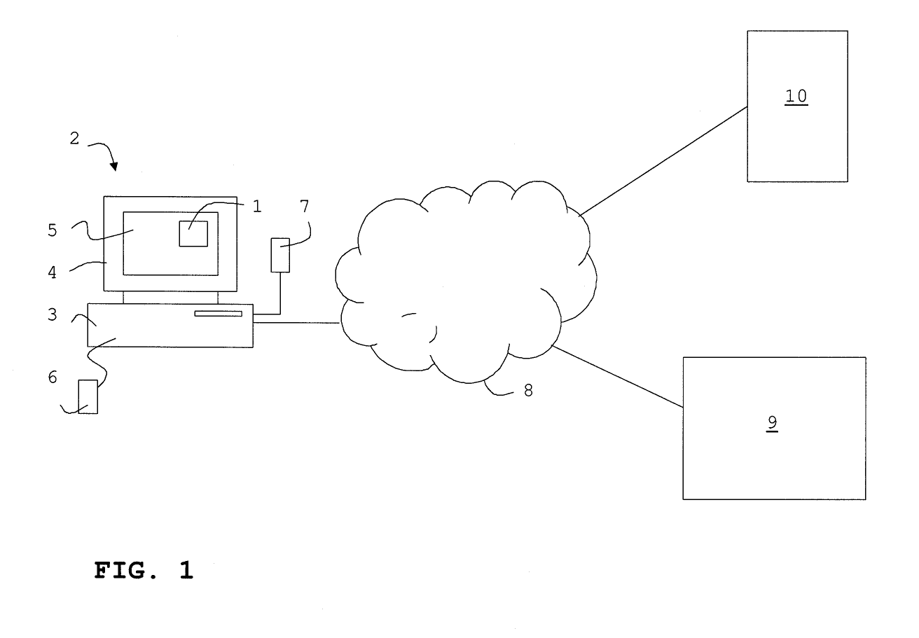

FIG. 1 shows a system for providing a banner 1 according to an embodiment of the invention. A user device 2 includes a computing unit 3 and a display panel 4 having a display area 5 capable of displaying information pages, such as web pages. The user device 2 is connected to a computer mouse or a similar pointing device 6 and one or more speakers 7.

The user device 2 is capable of connecting to a network 8, such as the internet, to establish a connection with a web server 9 and/or an advertisement server 10.

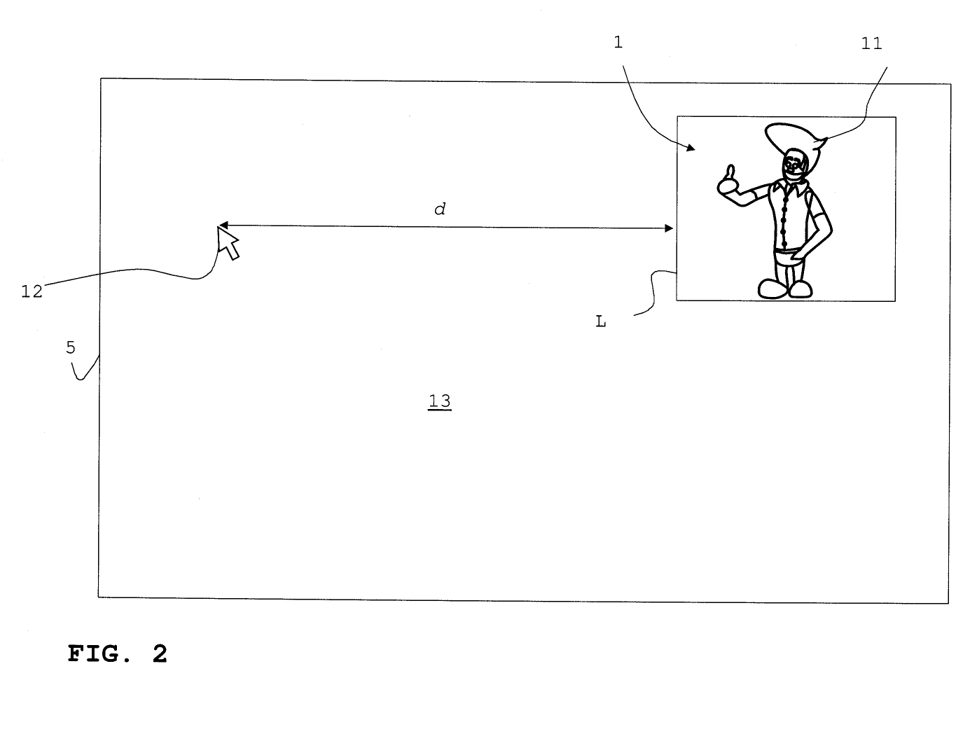

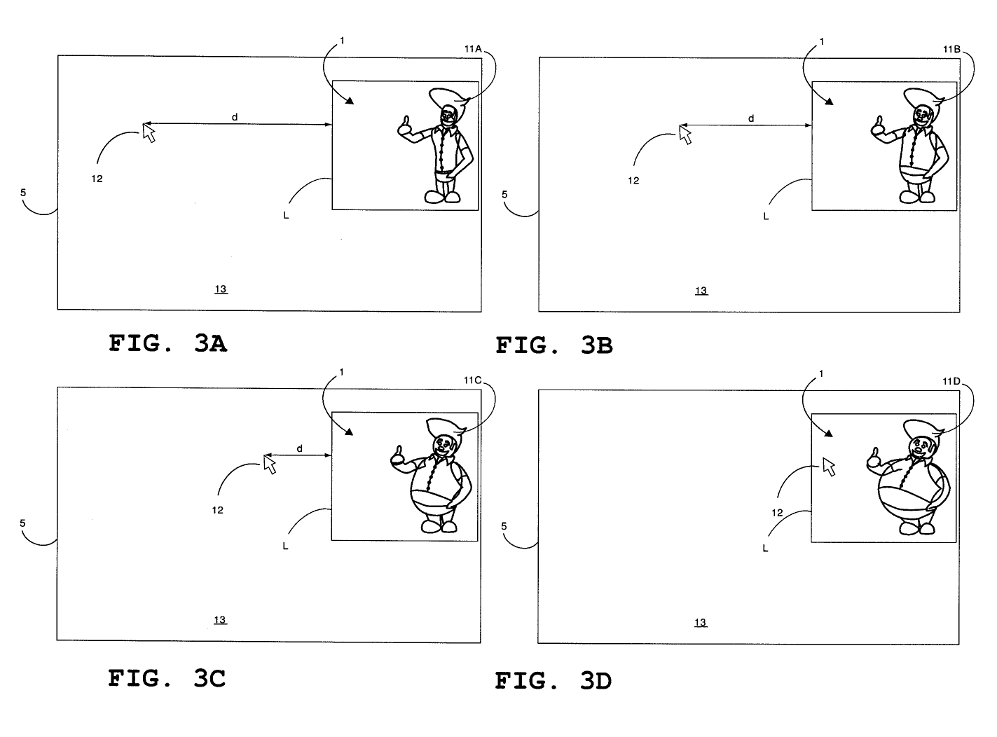

Before explaining operation of an embodiment of the invention, the embodiment is visualized with reference to FIG. 2 and FIGS. 3A-3D.

FIG. 2 shows the display area 5 of the display panel 2 in more detail, wherein a part of the display area embeds a banner 1 comprising a portion with a character 11. Further, a selection member 12, hereinafter also referred to as cursor 12, is shown on the display area 5. The cursor 12 is positioned on the web page 13 retrieved by using a browser over the internet 8 from the web server 9.

The banner 1 has variation means capable of varying the appearance of the character 11 in dependence on the distance d between the cursor 12 and a predetermined part of the display area 5.

Although the predetermined part may be located anywhere in the display area 5, preferably the predetermined part is a point, line or area in or near the boundary of the part of the display area displaying the banner 1. As illustrated in FIGS. 3A-3D, the distance d is measured between a boundary line L and the tip of the cursor 12. The proximity of the cursor 12 to the banner 1 determines what is displayed in the banner 1 on the display panel 4.

If a user operates the computer mouse 6, the cursor 12 moves over the display area 12 displaying the web page 13 and the distance d between the cursor 12 and the boundary line L varies, as illustrated in FIGS. 3A-3D. In dependence on the variation of the distance d, a plurality of appearances is shown (preferably a (quasi-)continuous series of appearances) of which four characters 11A-11D are displayed for the character 11. The character 11 grows fatter when the distance d decreases. Consequently, the attention of the banner 1 will increase.

It should be appreciated that the appearance of the character 11 may vary (quasi-) continuously with the distance d. As the sequence of appearances may be obtained by playing a certain frame associated with a distance d, it should be appreciated that instead of assigning an appearance to each particular distance d, an appearance may be assigned to a distance range covering an area or line segment of the displayed page. Preferably, more than two distance ranges or areas have been assigned a different appearance, such that movement of the cursor 12 by operating the mouse 6 over the display area 5 of the display panel 4 enables at least three appearances for the banner 1.

In FIGS. 3A-3D, the variation in the appearance of the banner 1 involves the variation of the contents of the banner 1, i.e. the character 11 appears to grow fatter. It should be appreciated that, alternatively or in addition, the appearance may vary with respect to the brightness, colour, focus, other content characteristics, perspective, size, shape and sound associated with said banner.

Sound may become louder or less loud over the speakers 7 in relation to the mouse cursor's 12 distance d to the banner 1.

An object, person, animal or text may come into focus or go back out of focus in relation to the mouse cursor's distance d to the banner. For example, the closer the mouse cursor 12 gets to the banner 1 in which a text is written, the more that text comes into focus (and vice versa).

Colour (in a picture, a text or an animation) may appear or disappear in relation to the mouse cursor's distance d to the banner. For example, the closer the mouse cursor 12 gets to the banner 1 in which a coral reef is depicted, the more colour that reef gets (and vice versa).

A predetermined frame of a movie or animation may be shown in dependence on the mouse cursor's 12 distance d to the banner 1, so that the user completely controls the playing of the movie (or animation) by moving the mouse cursor 12 towards- or away from the banner 1. As an example, the closer the mouse cursor 12 gets to the banner 1 in which a movie of an opening flower is shown, the more the flower opens (and vice versa).

Objects, people, animals or text may appear or disappear in relation to the mouse cursor's 12 distance d to the banner 1. For example, the closer the mouse cursor 12 gets to the banner 1 in which an empty sea is depicted, the more fish appear in that sea (and vice versa). As another example, the closer the mouse cursor 12 gets to the banner 1 in which a car is depicted, the more accessories the car gets equipped with (and vice versa).

Morphing of objects (-people, -animals or text) may be applied in a banner 1 may in relation to the mouse cursor's 12 distance d to the banner 1. For example, the closer the mouse cursor 12 gets to the banner 1 in which a morph of an apple and an egg is shown, the more the object looks like an apple and the less it looks like an egg (and vice versa).

The viewing perspective of a portion of the banner 1 may be varied in relation to the mouse cursor's 12 distance d to the banner 1. For example, the closer the mouse cursor 12 gets to the banner 1 in which an object is depicted, the higher the visitor's point of view on that object.

The zoom of a portion of the banner 1 may be varied in relation to the mouse cursor's 12 distance d to the banner 1. For example, the closer the mouse cursor gets to the banner in which a map of a country depicted, the more a point on that map is zoomed in on (and vice versa).

The speed in which an animation or a movie of a process takes place (or appears to take place) may be varied in relation to the mouse cursor's 12 distance d to the banner 1. For example, the closer the mouse cursor 12 gets to the banner 1 in which a driving car is shown, the faster that car drives (and vice versa).

The apparent time may be varied in relation to the mouse cursor's 12 distance d to the banner 1. For example, the closer the mouse cursor gets to the banner in which a face of a woman is depicted, the younger her face looks (and vice versa).

The expression of a person (persons), character, or animal (animals) may vary with the distance d between the cursor 12 and the banner 1. For example, the closer the mouse cursor 12 gets to the banner 1 in which a woman is depicted, the happier that woman looks (and vice versa). Or, the closer the mouse cursor 12 gets to the banner in which a dog is depicted, the more angry that dog looks (and vice versa).

The brightness of (a portion of) the banner 1 may change in dependence on the mouse cursor's 12 distance d to the banner. For example, the closer the mouse cursor 12 gets to the banner 1 in which the sun is depicted, the brighter the sun shines.

In a particularly advantageous embodiment of the invention, an appearance of the banner 1 is associated with a link comprising an address code for retrieving data and the variation means is capable of changing the address code when the appearance of the banner varies. The variation means of the banner change the address code (URL, e.g. from one deeplink to another deeplink) in dependence on the position of the cursor 12 on the display area 5, more preferably in dependence on the distance d between the mouse cursor 12 and the banner 1. In other words, the variation means determine, based on the position of the cursor 12 or the distance d between the cursor 12 and the banner 1, the relevant link for directing a user to the relevant web site or page. If the user clicks in the page outside the banner while not clicking on a valid URL in the page, a new window is opened or the existing window is replaced to show the data associated with the particular appearance of the banner 1.

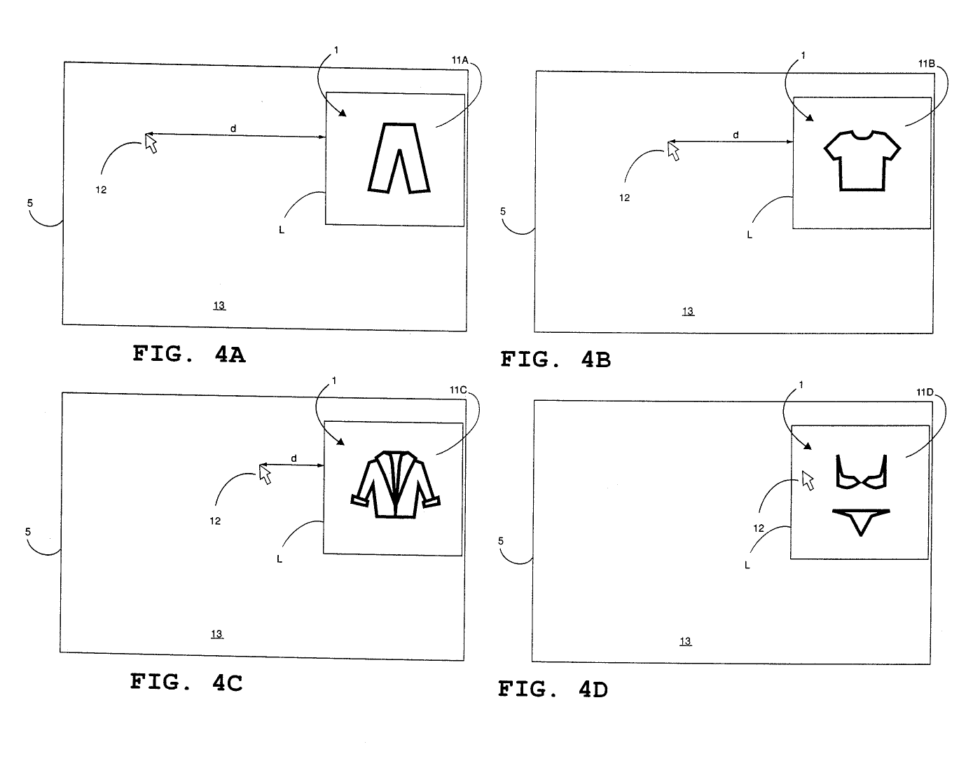

As an example and with reference to FIGS. 4A-4D, the appearance of a banner 1 showing a woman may vary with respect to the clothes she is wearing (FIGS. 4A-4D only show the displayed clothes for reasons of clarity). In FIG. 4A, the banner 1 shows pants 11A for a distance d; in FIG. 4B, the banner 1 shows a shirt 11B for a different distance d; in FIG. 4C, the banner 1 shows a jacket 11C for still another distance d and in FIG. 4D, the banner 1 shows lingerie 11D.

A user operating the mouse 6 and determining the clothes shown on the woman by controlling the distance d between the mouse cursor 12 and the banner 1, may click on a button (not shown) of the mouse 6 to directly retrieve data from the advertiser by visiting (pages of) his web site where more information about those particular clothes is available, or where the user can purchase those clothes. Alternatively, the user can retrieve data (such as the price or other extra information) from a web server 9 corresponding with the particular clothes shown.

If the user then varies the distance d, additional or alternative clothes are displayed in the banner 1. The address code for retrieval of data changes accordingly with this new appearance of the banner 1, such that a next click with the mouse 6 retrieves further or different data corresponding to the additional or alternative clothes.

As a further example, the appearance of a banner 1 showing a car may vary with respect to the accessories shown for the car. A user operating the mouse 6 and determining the accessories shown with the car by controlling the distance d between the mouse cursor 12 and the banner 1, may click a button (not shown) of the mouse 6 to retrieve data (such as the price) from a web server 9 corresponding with the particular accessories shown.

If the user then varies the distance d, additional or alternative accessories are displayed in the banner 1. The address code for the retrieval of data changes accordingly, such that a next click with the mouse 6 retrieves further or different data corresponding to the additional or alternative accessories.

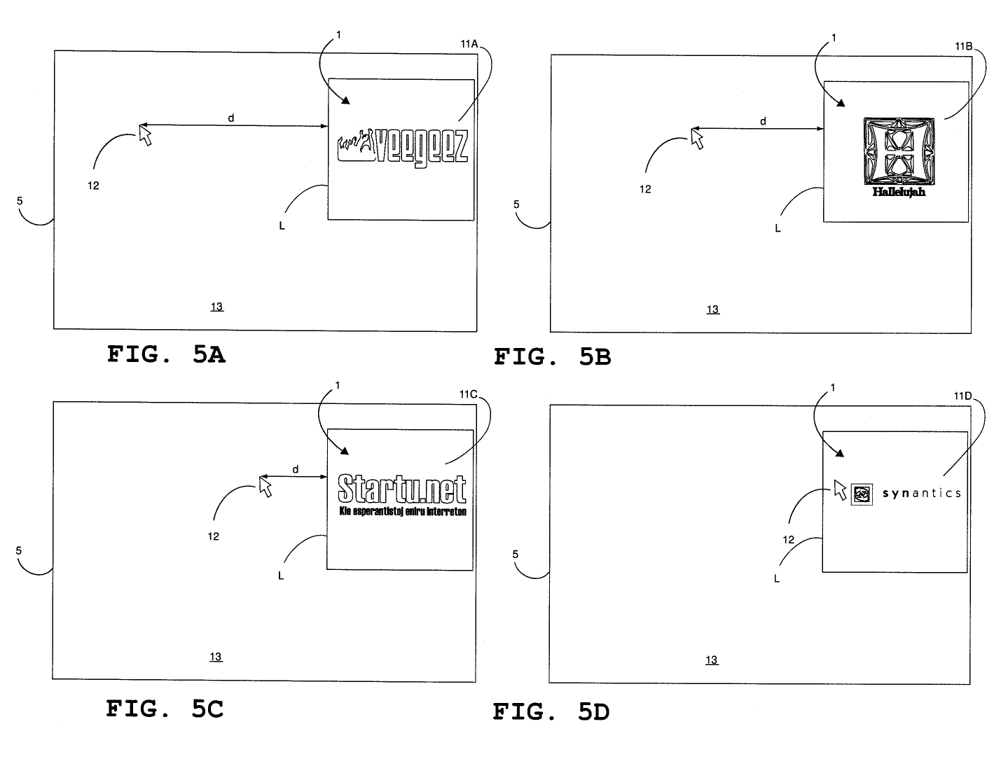

As another example, replacement of an advertisement/communication message 11A-11D from one advertiser to that of another advertiser (or other advertisers) in relation to the mouse cursor's 12 distance d to the banner 12 may be envisaged, as shown with reference to FIGS. 5A-5D. Preferably, this aspect is combined with the option to allow selection with the mouse 6 outside the banner 1 such that an address code is valid for a link to visit the site of the advertiser associated with the communication message 11A-11D shown for that distance d between the mouse cursor 12 and the banner 1. Consequently, a single banner 1 can be used more efficiently.

It should be noted that selection of the banner 1 for a certain appearance of (a portion of) said banner, takes place outside the banner 1 itself. The position within the banner 1 has even not necessarily assigned an address code for retrieving data. Furthermore, it should be appreciated that conventional hyperlinks in the web page 13 take precedence over the address codes assigned to the position of the cursor 12 in relation to the appearance of the banner 1.

Furthermore, it is noted that also the mere position of the cursor 12, or, more generally, the selection member 12, may be related to the address code. As an example, the display area 5 may be divided in regions, wherein each region is associated with a particular address code.

It should be appreciated that the above list of applications of the invention is not exhaustive and should not be interpreted as a limitation.

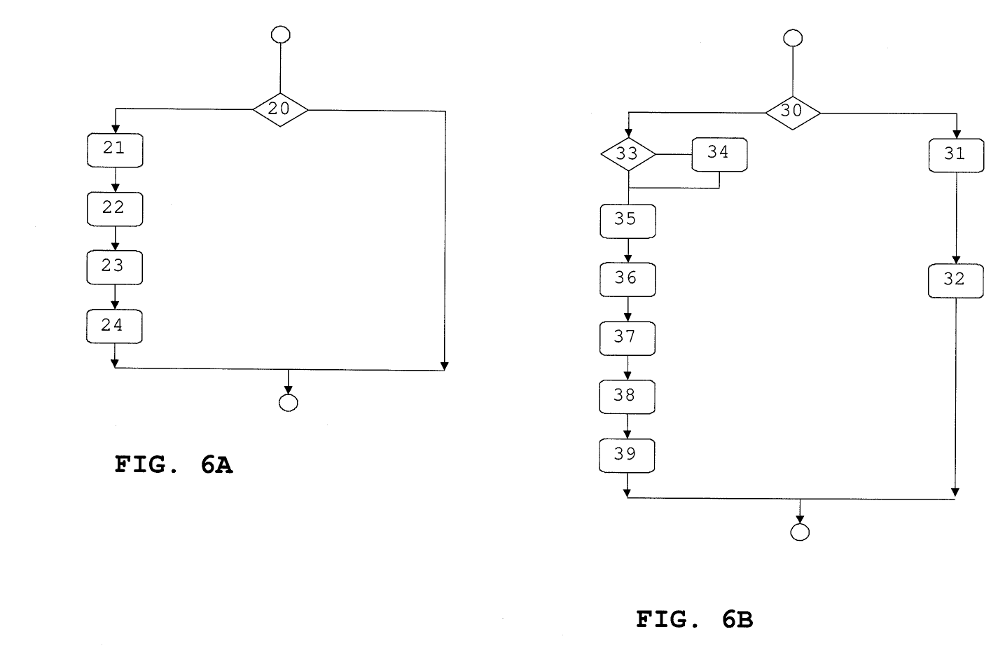

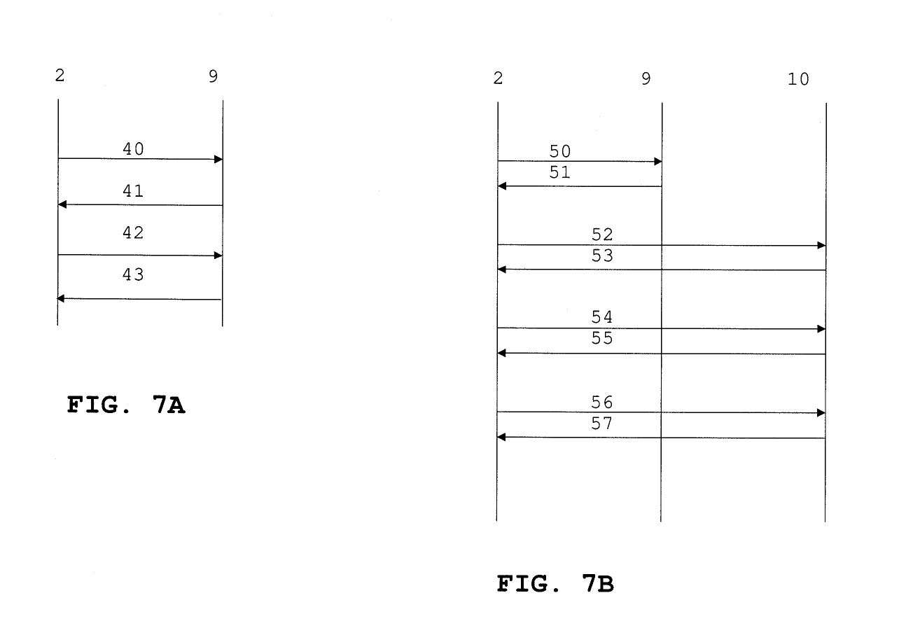

Next, the operation of an embodiment of the invention will be explained with reference to FIGS. 6A, 6B, 7A and 7B.

The invention can be applied by a set of computer instructions made available to the user device or client 2.

In FIG. 6A, it is first determined whether the cursor 12 moves over the display area 5 (step 20).

The instructions include a script, such as a Javascript, capable of running on the browser of the client 2 for determining the position of the mouse cursor 12 (step 21 in FIG. 6A) if the cursor 12 moves and optionally of the banner 1. The script, hereinafter also referred to as proximity script, passes these positions or values or parameters to the banner 1 (step 22).

The banner 1 includes a variation means, which for example comprises ActionScript code for a Macromedia Flash banner, and is capable of receiving the positions of the banner 1 and mouse cursor 12 from the proximity script. The ActionScript determines or calculates the distance d between the banner 1 or another part of the display area 5 and the mouse cursor 12.

In relation with the distance thus determined or calculated, the banner 1 or a portion thereof may display a particular appearance. For example, a certain frame may be played foe each distance d or range of distances d. It should be appreciated, however, that it is not necessary that a different frame is played for each distance or range of distances d. For example, one or more of the position coordinates of a picture of the banner may be altered in dependence on the distance d which gives motion of this picture in the banner area. Moreover, the dimensions of a picture in one or more directions, e.g. the height of a building, may be altered in accordance with the distance d between the banner 1 and the mouse cursor 12.

When the user operates the mouse 6, the Java script passes the values related to the position of the mouse cursor 12 to the variation means to determine or calculate the new distance d (step 23) and display the associated appearance by e.g. displaying the associated frame (step 24). During motion of the mouse cursor 12 over the display area 5, the distance d is preferably measured continuously.

In further detail, the proximity script may perform one or more of the following tasks, depicted as well in FIG. 6B.

The proximity script may check if the client browser has installed Macromedia Flash (step 30). If this is not the case, the script is aborted and alternative GIF banners are placed in the HTML code (step 31) of the web page, loaded and displayed (step 32). By using a DHTML banner, a variable banner, albeit with less smooth transitions between successive appearances, may still be obtained.

Further, the proximity script performs a check (step 33) whether the function/class for the banner list already exists to enable multiple banners on a web page 13. If not, a banner list may be created (step 34). The banner will be added to the banner list (step 35).

Still further, HTML tags will be inserted (step (36) including a reference to the variation means (ActionScript code) and a reference to the animation with the various appearances for the banner 1 itself.

After the page has loaded (step 37) with the variation means and the appearances (images/animation), the proximity script passes the position of the banner 1 to the variation means (step 38) and displays the banner (step 39).

The variation means may contain both the instructions for determining the distance d and the appearances. However, the instructions and/or appearances may also be separated in two or more files.

Finally, it is noted that determination or measurement of the distance d or position between the selection member 12 and the predetermined part L is not necessarily performed by the variation means. Basically, it is not relevant what component determines the distance d between the selection member 12 and the predetermined part. The variation means may, e.g., receive a distance parameter or a related parameter or value as determined by another component (e.g. of the Javascript running on the browser) as an input to display a certain appearance and to vary this appearance if another distance is determined.

The variation means is capable of loading the appearances from e.g. the advertisement server 10. Subsequently, the position of the banner 1 is received from the proximity script and the distance d can be determined. The variation means control the display of the correct appearance (image/animation/sound) for the banner 1. Furthermore, in case of the embodiment wherein different address codes are assigned to different appearances of the banner, the variation means controls this assignment.

FIG. 7A displays a dataflow chart illustrating a very simple embodiment of the invention using only a user device or client 2 and a web server 9 as displayed in FIG. 1.

A request 40 is directed from the client 2 to the web server 9 for a web page 13 in a manner known to the man skilled in the art. The web page 13 is returned in e.g. HTML format in reply 41 and includes banner script configuration. Subsequently, a further request 42 is made to the web server for one or more files referred to in the HTML web page 13, which files are returned in reply 43.

The downloaded data may include the set of instructions capable of performing the invention as described above. As an example, these data may include the proximity script, the variation means and the appearances for the banner 1.

The data for performing the embodiment of the invention are not necessarily obtained from the same server, as shown in FIG. 7B.

In FIG. 7B, a request 50 is directed from the client 2 to the web server 9 for a web page 13 in a manner known to the man skilled in the art. The web page 13 is returned in e.g. HTML format in reply 51 and includes banner script configuration. It should be noted that part of the banner script configuration may also be obtained from a further server, such as advertisement server 10, if a reference to such a further server is made. The proximity script (steps 52 and 53), the variation means (steps 54 and 55) and the appearances (steps 56 and 57) may subsequently be requested respectively received from the advertisement server 10.

The banner 1 offers a number of benefit's for visitors, advertisers and the advertising industry as a whole. The site's visitor has complete control over the message which is displayed in the banner 1. By moving the mouse cursor 12 towards or away from the banner 1, the visitor determines which part of the content of the banner 1 is displayed. Instead of being subject to the usual (often very intrusive) forms of online advertising, the visitor is in charge of his or her screen again.

This user driven interactivity creates sympathy towards both the medium and the ad and therefore increases the effectiveness of the communication message displayed in the banner. At the same time, it decreases the aversion towards banners in general, which has become a serious problem for both advertisers and sites.

Because of the direct correlation between the content of the banner 1 and the visitor's activity on the display area 5, the banner will attract extra attention. People are so used to banners that blink, move, or use other forms of animation, that they subconsciously block it and therefore are not reached by the banner's message. However they do focus on the mouse cursor 12 and it's effect on the content of the screen.

Both the visitor's reflexive attention from the interactively controlled movement in the banner 1 and the selective attention from the realisation of this control over the banner help getting the advertiser's message across. This in turn, will yield a better click through rate (the percentage of visitor's that click on the banner) and therefore a better return on the media investment of the campaign.

This new technique opens a whole range of new possibilities for banner campaigns on the internet. From a creative's point of view, the link between the user, the banner and the message displayed there-in allows for totally different concepts than are used in the current static, or autonomically animated banners.

1. A banner capable of being displayed on a part of a display area of a display panel which display area further is capable of displaying a selection member, wherein said banner optionally is capable of being selected by said selection member, and wherein said banner comprises variation means capable of varying the appearance of at least a portion of said banner on said display area in dependence on the distance (d) between said selection member and a predetermined part (L) of or outside said display area.

2. The banner according to claim 1, wherein said predetermined part is located in or determined with respect to said part of said display area displaying said banner.

3. The banner according to claim 1, wherein said variation means is capable of receiving position coordinates of said selection member and determining said distance on the basis of said received position coordinates.

4. The banner according to claim 1, wherein said variation means is capable of selecting one or more banner appearances out of a plurality of banner appearances corresponding to said distance or range of said distances and displaying said banner appearances.

5. The banner according to claim 1, wherein said distance (d) is determined for substantially each position or range of positions of said selection means on said display area and said variation means is capable of varying said appearance for substantially each determined distance.

6. The banner according to claim 1, wherein said variation of said appearance of at least said portion of said banner is selected from one or more banner characteristics of the group comprising brightness, colour, content, focus, perspective, size, shape and sound associated with said banner.

7. The banner according to claim 1, wherein an appearance of said banner is associated with a link comprising an address code for retrieving data and said variation means is capable of changing said address code when said appearance varies.

8. The banner according to claim 1, wherein said display panel His capable of receiving image data from a computing unit to display said banner and said variation means is capable of selecting one or more banner appearances out of a plurality of banner appearances available at said computing unit corresponding to said distance or range of said distances and displaying said banner appearances.

9. A method for providing a banner over a network on a part of a display area of a display panel of a computing unit, said computing unit being connectable to said network, wherein said banner is capable of being selected by a selection member, said method comprising providing variation means capable of varying the appearance of at least a portion of said banner on said display area in dependence on the distance (d) between said selection member and a predetermined part of said display area.

10. The method according to claim 9, wherein said computing unit is capable of running a browser for retrieving and displaying an information page on said display panel and wherein said method further comprises providing a position determination means for said browser capable of determining the position of said selection member on said display area and/or said information page.

11. The method according to claim 9, wherein said computing unit is capable of running a browser for retrieving and displaying an information page on said display panel and wherein said method further comprises providing a position determination means for said browser capable of predetermining the position of said part on said display area displaying said banner.

12. The method according to claim 10, further comprising providing said page from a first server and providing said variation means and/or said position determination means from a second server, wherein said first server and second server are capable of establishing a connection with said computing unit over said network.

13. (canceled)

14. A server arranged for providing a banner to a computing unit over a network, said computing unit being connectable to a display panel for displaying said banner on a part of a display area of said display panel, said banner being selectable by a selection member, wherein said banner comprises variation means capable of varying the appearance of at least a portion of said banner on said display area in dependence on the distance (d) between said selection member and a predetermined part of said display area.

15-16. (canceled)

17. A banner capable of being displayed on a part of a display area of a display panel which display area further is capable of displaying a selection member, wherein said banner optionally is capable of being selected by said selection member and wherein an appearance of said banner is associated with a link comprising an address code for retrieving data and wherein said banner comprises variation means capable of changing said appearance and said address code in dependence on the position of said selection member on said display area.

18. A banner capable of being displayed on a part of a display area of a display panel which display area further is capable of displaying a selection member, wherein said banner optionally is capable of being selected by said selection member, said banner comprising variation means capable of assigning an address code to said banner in dependence on the position of said selection member on said display area.

19-25. (canceled)
